(19) United States
(12) Patent Application Publication
(10) Pub. No.: US 2025/0383774 A1
(43) Pub. Date: Dec. 18, 2025

(54) FAST PROGRAMMING FOR MEMORY SYSTEMS

(71) Applicant: Micron Technology, Inc., Boise, ID (US)

(72) Inventors: Luca Porzio, Casalnuovo (NA) (IT); Paolo Amato, Treviglio (BG) (IT); Marco Onorato, Villasanta (MB) (IT); Christian M. Gyllenskog, Meridian, ID (US); Nicola Colella, Capodrise (CE) (IT)

(21) Appl. No.: 19/232,518

(22) Filed: Jun. 9, 2025

Related U.S. Application Data
(60) Provisional application No. 63/659,745, filed on Jun. 13, 2024.

(51) Int. Cl. G06F 3/06

(52) U.S. Cl. CPC G06F 3/0611; G06F 3/0634; G06F 3/0659; G06F 3/0673

(57) ABSTRACT

Methods, systems, and devices for fast programming for memory systems are described. A memory system may include an interface with a host system. The memory system may receive an indication of a quantity of data that is to be received and written to the memory system while operating in a programming mode. The memory system may store the indication to a register as a value. The memory system may modify (e.g., decrement) the value of the register as data is written to the memory system. In response to the value of the register satisfying a threshold (e.g., reaching zero), the memory system may disable the programming mode. The memory system may disable or delay maintenance operations while operating in the programming mode to reduce writing latency and decrease programming times.

### CROSS REFERENCE

The present Application for Patent claims priority to U.S. Patent Application No. 63/659,745 by Porzio et al., entitled “FAST PROGRAMMING FOR MEMORY SYSTEMS,” filed Jun. 13, 2024, which is assigned to the assignee hereof, and which is expressly incorporated by reference in its entirety herein.

### TECHNICAL FIELD

The following relates to one or more systems for memory, including fast programming for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports fast programming for memory systems in accordance with examples as disclosed herein.

FIG. 2 shows a block diagram of a system that supports fast programming for memory systems in accordance with examples as disclosed herein.

FIG. 3 shows an example of a process that supports fast programming for memory systems in accordance with examples as disclosed herein.

FIG. 4 shows a block diagram of a memory system that supports fast programming for memory systems in accordance with examples as disclosed herein.

FIG. 5 shows a flowchart illustrating a method or methods that support fast programming for memory systems in accordance with examples as disclosed herein.

### DETAILED DESCRIPTION

Some memory systems may be programmed with data at various stages of being implemented into a larger system (e.g., a final product, a complete system). In some examples, a memory system may operate in a pre-soldering activity (PSA) programming mode, where the memory system may be programmed with data before being implemented (e.g., soldered) into the larger system, such as before being soldered (e.g., mounted) to a circuit board (e.g., printed circuit board (PCB)) for implementation into the larger system (e.g., such as a vehicle, an infotainment center, a smart phone, a smart watch, among other systems into which the memory system may be implemented). In another example, the memory system may be programmed via in-system programming (ISP) (e.g., a factory programming mode, a manufacturing programming mode), where the memory system may be programmed after, for example, being mounted to a circuit board for implementation into the larger system. In some cases, ISP may enable a manufacturing process of the memory system to integrate programming, testing, and assembly into a single production phase, for example, rather than using multiple production phases to support programming before system assembly (e.g., as with PSA programming).

Maintenance operations may be performed on some memory systems prior to writing data to a memory device of the memory system. For example, the memory device may include old or outdated data, or may otherwise not have enough free storage to perform a write operation. In this case, a garbage collection operation may be performed (e.g., prior to or during the write operation). However, garbage collection operations and other maintenance operations may use additional resources that increase the overall latency of writing data to the memory device. In some examples, performing one or more garbage collection operations prior to or during a set of write operations may increase latency (e.g., slow) both the garbage collection operations and the write operations. Maintenance operations as well as PSA and ISP programming operations may occur in a manufacturing setting. As such, increased latency associated with such maintenance and programming operations may increase the cost of the memory system, for example, in terms of the quantity of memory systems that can be produced per unit of time, time spent by technicians managing the programming of such memory systems, and the like. Thus, reducing the duration of these maintenance and programming operations may be desired.

The techniques, devices, and methods described herein provide for reduced maintenance operations and more efficient programming operations, resulting in reduced costs, among other advantages. In some examples, a memory system may include an interface with a host system. The memory system may receive (for example, via the interface) an indication of a quantity of data that is to be received and written to the memory system while operating in a programming mode (e.g., a PSA mode, an ISP mode). The memory system may store the indication to a register as a value. The memory system may prepare to receive the quantity of data associated with the programming mode without performing garbage collection operations or other maintenance operations, or may perform fewer garbage collection operations or other maintenance operations than would otherwise be performed.

The memory system may, in some examples, receive one or more commands to write data to the memory system, where based on each command to write data, the memory system may modify (e.g., overwrite, update, decrement) the value of the register in accordance with the quantity of data written to the memory system (e.g., as part performing the write command). The value may track, in some examples, an amount of data that remains to be written to the memory system. In response to the value of the register reaching a given value (such as equaling zero) the memory system may exit or disable the programming mode.

To reduce latency associated with the write operations performed during the programming mode, the memory system may perform, disable, or delay one or more operations of the memory system that are associated with writing the data to the memory system to decrease programming times while operating in the programming mode. For example, the memory system may disable or delay garbage collection operations, error correction operations, power loss management, or read checks; reallocate volatile memory for faster logical-to-physical (L2P) mapping information updates; or any combination thereof, among other operations described herein, to increase the performance of the programming mode. An example of improving the performance of the programming mode may include reducing or eliminating a latency associated with performing the maintenance operations while the process of performing write operations. In this way, the memory system (e.g., operating in the programming mode) may reduce the programming time, thereby decreasing costs associated with programming the memory system.

In addition to applicability in memory systems as described herein, techniques for an in-system programming interface may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing time spent performing maintenance operations (e.g., garbage collection) and improving writing speeds, which may decrease latency associated with programming time (e.g., during manufacturing), reducing costs associated with programming the memory, among other benefits.

Features of the disclosure are illustrated and described in the context of systems, devices, and circuits. Features of the disclosure are further illustrated and described in the context of a process and flowcharts.

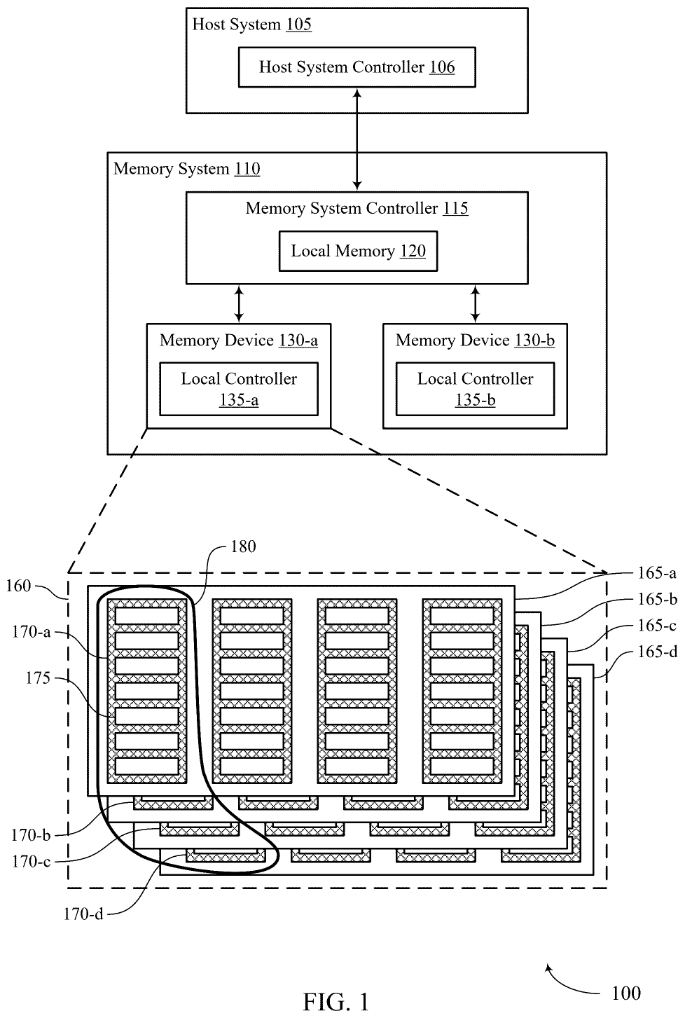

FIG. 1 shows an example of a system 100 that supports fast programming for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may include any device or collection of devices, where the device or collection of devices includes at least one memory array. For example, a memory system 110 may include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. The local memory 120 may include one or more registers. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may include a NAND device (e.g., NAND flash device). A memory device 130 may include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. Such operations may be referred to as maintenance operations. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 may include any quantity of non-transitory computer readable media that support fast programming for memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

Some memory systems 110 may be programmed with data at various stages of being implemented into a larger system (e.g., a final product, a complete system). In one example, the memory system 110 may operate in a PSA programming mode, where the memory system 110 may be programmed with data before being implemented (e.g., soldered) into the larger system, such as before being soldered (e.g., mounted) to a circuit board (e.g., PCB) for implementation into the larger system (e.g., such as a vehicle, an infotainment center in a vehicle, a smart phone, a smart watch, among other systems into which the memory system 110 may be implemented). In another example, the memory system 110 may be programmed via an ISP (e.g., a factory programming mode, a manufacturing programming mode), where the memory system 110 may be programmed after, for example, being mounted to a circuit board for implementation into the larger system.

The techniques, devices, and methods described herein provide for reduced maintenance operations and more efficient write operations, resulting in reduced costs, among other advantages. In some examples, the memory system 110 may include an interface with the host system 105. The memory system 110 may transmit (e.g., via the interface to the host system 105) an indication that a given programming mode is supported. If the programming mode is supported, the memory system 110 may operate according to that programming mode during a write operation (e.g., a system update, a download).

The memory system 110 may transmit (e.g., via the interface to the host system 105) a maximum data size that the memory system 110 supports during programming. The memory system 110 may receive (for example, via the interface) an indication of a quantity of data that is to be received and written to the memory system 110 while operating in the programming mode (e.g., a PSA mode, an ISP mode). The memory system 110 may store (e.g., to a register) the indication as a value. The memory system 110 may prepare to receive the quantity of data (e.g., reserve one or more blocks 170 for a write operation) associated with the programming mode without performing garbage collection operations or other maintenance operations, or may perform fewer garbage collection operations or other maintenance operations than would otherwise be performed. Accordingly, the memory system 110 may decrease latency for the write operations performing during the programming mode.

The memory system 110 may, in some examples, receive one or more commands (e.g., via the interface) to write data to the memory system 110, for example to a die 160 (e.g., to a block 170 of a die 160). Each command may be associated with an amount of data that is less than or equal to the maximum data size that the memory system 110 supports during programming. The memory system 110 may modify (e.g., overwrite, update, decrement) the stored value in accordance with the quantity of data written to as part performing the write command. The stored value may be updated as write commands are received, for example, to track an amount of data that remains to be written to the memory system 110 from the host system 105. The host system 105 may track and set the stored value to satisfy a threshold value (e.g., be equal to or less than a maximum data size). In response to the stored value reaching a given value, such as equaling zero, the memory system 110 may exit or disable the programming mode.

To reduce latency associated with the write operations, the memory system 110 may perform, disable, or delay one or more operations of the memory system 110 that are associated with writing the data to the memory system 110 to decrease programming times while operating in the programming mode. For example, the memory system 110 may: disable or delay garbage collection operations, error correction operations, power loss management, or read checks; reallocate volatile memory for faster L2P mapping information updates; or any combination thereof, among other operations described herein, to increase the performance of the programming mode, for example, by reducing or eliminating a latency associated with performing these operations. In this way, the memory system 110 (e.g., operating in the programming mode) may reduce the programming time, thereby decreasing costs associated with programming the memory system 110.

The system 100 may include any quantity of non-transitory computer readable media that support fast programming for memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

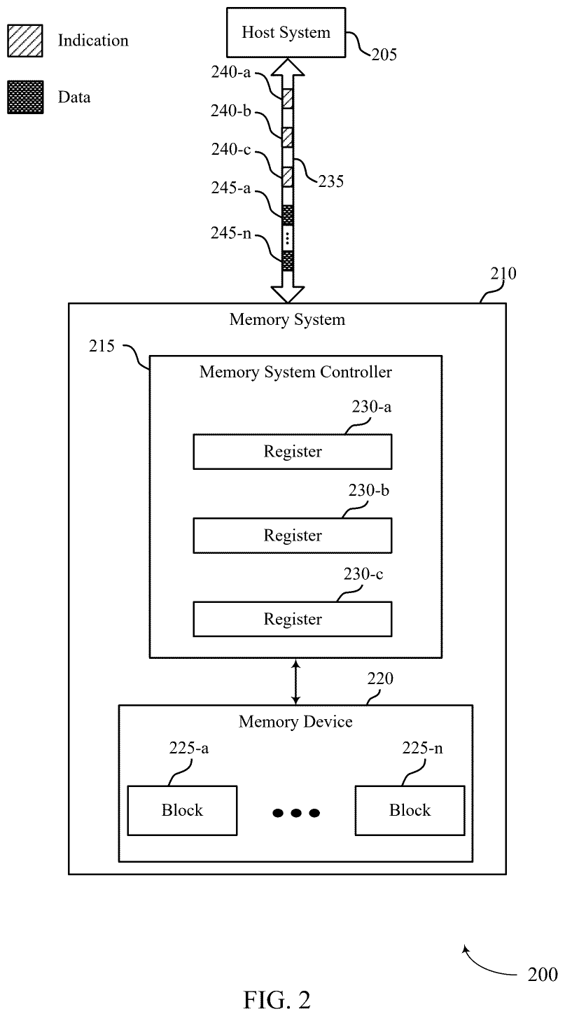

FIG. 2 shows an example of a system 200 that supports fast programming for memory systems in accordance with examples as disclosed herein. The system 200 may implement, or be implemented by, aspects of the system 100 as described herein. For example, the system 200 may include a host system 205, a memory system 210, a memory system controller 215, and a memory device 220, which may be examples of corresponding devices and systems described herein with reference to FIG. 1. The memory system controller 215 may be coupled with the memory device 220 and may be configured to perform one or more access operations (e.g., such as read or write operations) on one or more physical addresses of blocks 225 (e.g., block 225-a through block 225-n) in the memory device 220. In some examples, write operations may be referred to programming operations and write commands may be referred to programming commands.

The memory device 220 may include any quantity of blocks 225 (e.g., blocks 225-a through 225-n). The memory system controller 215 may include one or more registers 230. In other examples (not shown) the memory system controller 215 may be configured to access one or more registers 230 located external to the memory system controller 215 (e.g., the registers 230 may be located external to the memory system controller 215). Registers 230-a, 230-b, and 230-c may be separate registers or may be portions of a single register, or any combination thereof. For example, if a single register 230, the indications 240 described herein may be stored as respective bits. By way of example, a register 230 may include bits [0:N], where an indication 240-a may be stored to a first subset of the N bits, an indication 240-b may be stored to a second subset of the N bits, and an indication 240-c may be stored to a third subset of the N bits.

An interface 235 may couple the host system 205 and memory system 210. The host system 205 and the memory system 210 may communicate (e.g., indications 240, data, 245, commands, updated values, etc.) via the interface. An indication 240 may include one or more bits.

In some examples, the host system 205 may be, or be a part of, a manufacturing system operable to program the memory system 210 with data before (e.g., as part of) the memory system 210 being implemented into a larger system (e.g., such as a final product, customer host system, or the like). For example, the memory system 210 may operate in a PSA programming mode, where the memory system 210 may be programmed (e.g., in-system programming), by the host system 205, with data 245 before being implemented (e.g., soldered) into the larger system (e.g., such as a car, phone, smart watch, or the like). In some examples, the memory system 210 may operate in an PSA programming mode, where the memory system 210 may be programmed with data 245 before being implemented (e.g., soldered) into the larger system, such as before being soldered (e.g., mounted) to a circuit board (e.g., printed circuit board (PCB) for implementation into the larger system.

In some examples, the memory system 210 may operate in an ISP mode, where the memory system 210 may be coupled with (e.g., soldered to, mounted to) a PCB (e.g., a customer system) and programmed with data 245 before being implemented into the final product or before being provided to the customer. Such operations (e.g., ISP or PSA programming) may be performed in a manufacturing setting (e.g., factory environment), for example, before providing the memory system 210 to customers. As such, if there are a relatively large quantity of memory systems 210 to be programmed, the time spent in the programming stage may affect the cost of the memory system 210. That is, the time spent to program such memory systems 210 in the manufacturing setting may result in increases to costs, money, and resources, for example, in terms of a quantity of technicians managing the programming, a quantity of programmers, a quantity of memory systems 210 to be programmed (e.g., ready) per day, or the like. As such, it may be desirable to reduce the duration of such write operations (e.g., reduce programming time to be as minimal as possible).

The system 200 may support a programming mode (e.g., a manufacturing programming mode, such as an ISP or PSA mode) that reduces the latency associated with programming data to the memory system 210 while operating in the programming mode. For example, to achieve relatively faster throughput and reduced latency for such programming modes (e.g., ISP and PSA operations), the memory system 210 may write data 245 in accordance with a programming command sequence. For instance, the memory system 210 may receive a command for ISP or PSA programming, where the command for ISP or PSA programming may include a total quantity of LBAs associated with the programming mode, an indication of multiple LBA ranges (e.g., respective LBA start addresses and quantities of LBA ranges for each LBA range), or both.

In accordance with the command, the memory system 210 may receive write commands and may program the memory system 210 with the data 245. While operating in the PSA or ISP modes, the memory system 210 may perform, disable, or delay one or more operations (e.g., maintenance operations) in order to improve performance. For example, the memory system 210 may perform L2P updates before writing data 245 to the physical addresses of the memory system 210. Further, the memory system 210 may disable, or otherwise delay, maintenance operations, power loss management, change log management operations, L2P table management (e.g., concurrent with or after writing the data 245), background operations, parity checks, read checks, or the like.

The host system 205 and memory system 210 may be coupled via an interface 235, such that each device may communicate data, indications, commands, requests, or the like. For example, the memory system 210 may transmit, to the host system 205 via the interface 235, indication 240-a and 240-b. The host system 205 may transmit, to the memory system 210 via the interface 235, indication 240-c and data 245-a through 245-n.

Table 1 gives examples of the indications 240 stored to the respective registers 230 (or, in some examples, to a single register). For example, bUFSFeatureSupport[X] may refer to indication 240-a stored to register 230-a and may have a default value of 1b. In some examples, the register 230-a may be a read-only register, where the host system 205 is able to read the contents of the register 230-a. For example, the access mode of the bUFSFeatureSupport[X] may be set to “read-only” (e.g., RO) such that the host system 205 may read the register 230-a may not be configured to write to the register 230-a. In some cases, the memory system 210 may be configured to write to the register 230-a and/or read the register 230-a.

In some examples, dFastProgramMaxDataSize may refer to indication 240-b stored to register 230-b, and may include a vendor-specific value. In some examples, the register 230-b may be a read-only register, where the host system 205 is able to read the contents of the register 230-b. For example, the access mode of the dFastProgramMaxDataSize may be set to “read-only” (e.g., RO) such that the host system 205 may read the register 230-b may not be configured to write to the register 230-b. In some cases, the memory system 210 may be configured to write to the register 230-b and/or read the register 230-b.

In some examples, dFastProgramDataSize may refer to indication 240-c stored to register 230-c. In some examples, the register 230-c may include a volatile memory, and may be a read-write register, where the host system 205 is able to read from and write to the register 230-c. In some examples, the register 230-c may include a default value of zero (0). For example, the access mode of the dFastProgramDataSize may be set to “read-write” (e.g., RW) such that the host system 205 may read the register 230-c and may be configured to write to the register 230-c. In some cases, the memory system 210 may be configured to write to the register 230-c and/or read the register 230-c.

TABLE 1

| | Access | Default | |
|---|---|---|---|
| Register name | mode | value | Description |
| bUFSFeaureSupport[X] | RO | 1b | A new feature support bit must be |
| | | | requested in Jedec to declare the feature is |
| | | | supported by the given device |
| dFastProgramMaxDataSize | RO | Vendor | Device can declare a maximum size which |
| | | specific | can be supported while programming. |
| | | | This size may change during lifetime so it |
| | | | must be checked before starting the ISP |
| | | | process flow. |
| dFastProgramDataSize | RW, | 0 | Amount of data that the host plans to load |
| | Volatile | | to all logical units. Data is expressed in 4 KB |
| | | | units. Value reported here is set by host |
| | | | initially and it can be decremented by |
| | | | device during the programming flow; host is |
| | | | expected to track this register and set to a |
| | | | value which is lower than |
| | | | dFastProgramMaxDataSize at any given |
| | | | time. |
| | | | Setting this value to zero means that the |
| | | | Fast-programming mode is disabled. |
| | | | This register is reset at each power cycle |
| | | | hence the fast-programming mode is |
| | | | disabled at each power cycle as well. |

The memory system 210 may transmit, to the host system 205, an indication 240-a that the memory system 210 is capable of a programming mode (e.g., that a programming mode is supported by the memory system 210). As used herein, “transmit” (or “transmitting”) may refer to the memory system 210 transmitting the indication 240-a as part of a signal over one or more conductive lines (e.g., DQ lines or other lines coupled with the host system 205). In other examples, “transmit” (or “transmitting”) may refer to the host system 205 reading a register 230 to determine one or more values, such as a maximum size of supported data. That is, the value(s) stored to a register 230 may be transmitted to the host system 205.

Indication 240-a may include one or more bits and may be set (e.g., written) during a manufacturing process. The indication 240-a may be a declaration descriptor and may declare (e.g., indicate) a capability of the memory system 210 to support (or not support) a programming mode. The indication 240-a may be stored to the register 230-a, at any position of the register 230-a. The indication 240-a may be stored to read-only memory from the perspective of the host system 205.

In response to entering the programming mode, the memory system 210 may perform, delay, or otherwise disable, one or more operations (e.g., maintenance operations) in order to improve performance of the write operations. For example, the memory system 210 may disable garbage collection, change log management operations, one or more error correction procedures, read checks, or any combination thereof, of the memory system 210. In such examples (e.g., disabling the change log management), the memory system 210, in response to entering the programming mode, may release one or more resources of a volatile memory device of the memory system 210 (e.g., releasing all of the resources of the volatile memory device) to load (e.g., transfer) respective portions of the L2P table to the volatile memory device and update the L2P table before writing the data 245 to the physical addresses of the memory device 220). In this way, the memory system 210 may disable the change log management in order to perform the programming operation efficiently, thereby reducing programming time. In some other examples, the memory system 210 delay updating the L2P table until after the completion of the programming mode. In some cases, the memory system 210 may refrain from disabling the change log management if delaying updating the L2P table. Additionally, or alternatively, the memory system 210 may determine a type of memory cell to which to write data while in the programming mode, trim parameters for writing to the type of memory cell, or a combination thereof.

Indication 240-b may be one or more bits that indicate a maximum quantity of data supported by the memory system 210 during programming (e.g., a maximum quantity of data capable of being written to the memory system 210). The indication 240-b may be stored to the register 230-b. The indication may be stored to read-only memory from the perspective of the host system 205. The maximum quantity of data that the memory system 210 may support may depend on the internal state of the memory system 210 and may be vendor-specific. For example, the maximum quantity of data that is supported may be based on a quantity of empty blocks, a quantity of blocks reserved for provisioning, a quantity of blocks reserved for tables and other internal management operations, etc. of the memory system 210. In some instances, the maximum quantity of data that is supported may be a maximum size of a write operation (e.g., a single write operation, the maximum size of a single write operation) or may be a maximum size of a plurality of write operations (e.g., the maximum size across a plurality of write operations). In some cases, this register may be set to a defined value that indicates that a maximum data size has not been indicated by the memory system 210. In this manner, it may be optional to set a max data size for the memory system 210.

The maximum quantity of data that may be supported by the memory system 210 may be different for different types of memory systems 210 and may change over time. Accordingly, the memory system 210 may update the value stored to the register 230-b and may communicate the updated maximum supported quantity of data to the host system 205. The memory system 210 may communicate the maximum quantity of data supported by the memory system 210 to the host system 205, even if the memory system 210 previously communicated the maximum quantity of data supported (e.g., during a previous write operation).

The memory system 210 may be programmed multiple times and have a different maximum supported quantity of data each time. In some examples, a memory system 210 may undergo a first write operation as part of being placed into a first system such as a PCB. The first write operation may take up or use some memory (e.g., reserve blocks) such that less memory is available for subsequent write operations. The memory system 210 (in the first system) may then undergo a second write operation (e.g., install or program additional code), as part of being placed into a second system (e.g., an infotainment system). The maximum supported quantity of data for the second write operation may be less than the maximum supported quantity of data for the first write operation.

The memory system 210 (in the second system) may then undergo a third write operation (e.g., at a different location or factory than a previous write operation), as part of being placed into a third system (e.g., a vehicle such as a car). The maximum supported quantity of data for the third write operation may be less than the maximum supported quantity of data for the second write operation. The indication 240-b transmitted to respective host systems associated with each write operation may indicate a different maximum supported quantity of data of the memory system 210. In other examples, the memory system 210 may support an increased maximum quantity of data through time due to maintenance operations (e.g., garbage collection, data compaction) performed between write operations that free-up blocks. The memory system may update the register 230-b to update the indication 240-b based on a current condition of the memory system 210.

In some examples, the host system 205 may transmit, via the interface 235, a write command to the memory system 210. The memory system controller 215 may receive and process such commands to write data 245 to one or more blocks 225 (e.g., virtual blocks 180, blocks 170) of the memory device 220. In another example, the host system 205 may transmit a read command, instructing the memory system 210 to retrieve and transmit data 245 to the host system 205. In such examples, the memory system controller 215 may retrieve the requested data 245 from one or more blocks 225 of the memory device 220 and transmit the requested data 245 to the host system 205 via the interface 235.

In some examples, the host system 205 may transmit a command to perform an access operation. The command may include data 245. In response, the memory system controller 215 may be configured to perform the access operation on the data 245 (e.g., write the data to a physical address or read the data from the physical address). The memory system 210 may update logical-to-physical (L2P) tables to indicate to which physical addresses the data 245 for the logical block addresses (LBAs) is written (e.g., as part of a write operation).

Indication 240-c may include one or more bits that indicate a quantity of data that the host system 205 plans to program (e.g., load, install, write) to the memory system 210. The host system 205 may transmit the indication 240-c to the memory system 210, and the memory system 210 may store the indication 240-c to the register 230-c. The indication 240-c may be stored to read-write memory from the perspective of the host system 205 and may be stored in volatile memory. The indication may be based on (e.g., equal to or less than) the maximum supported quantity of data communicated with the host system 205 as part of the indication 240-b.

The memory system 210 may receive multiple commands from the host system 205, where each command includes data 245 (e.g., data 245-a through data 245-n). The data 245 may be any size (e.g., 4 KB units) and the host system 205 may transmit any quantity of units (e.g., data units). The memory system controller 215 may be configured to receive and process (e.g., perform) such commands. As an illustrative example, the memory system 210 may receive data 245-a and the memory system controller 215 may write the data 245-a to physical addresses of one or more of the blocks 225 of the memory device 220. The memory system 210 may receive and perform such commands until the data 245 has been written to the memory device 220.

The value stored to the register 230-c may change over time. For example, at the start of the write operation, the indication 240-c may be stored to the register 230-c. As the host transmits write commands and data 245 (e.g., during the programming flow), the memory system 210 may modify the value stored to the register 230-c. For example, the value stored to the register 230-c may indicate a remaining portion of data that the host system 205 plans to program to the memory system 210. As the host system 205 programs data to the memory system 210, the value stored to the register 230-c may be modified (e.g., decremented) after or during each write command, according to the quantity of data 245 associated with that write command. In some examples, the memory system may transmit the value stored at register 230-c to the host system 205.

In some examples, the value stored to the register 230-c may indicate a size of data associated with a write command. The host system 205 may track, set, and update the value stored to the register 230-c to ensure that the size of the data associated with each write command is equal to or less than the maximum supported quantity of data as indicated in indication 240-c. The size of the data may be measured in bits, blocks (e.g., blocks 225), or another unit. In some examples, the memory system may transmit the value stored at register 230-c to the host system 205.

The register 230-c may be reset at each power cycle. A power cycle may include turning off and on power to a portion of the memory system 210 or the whole memory system 210. The memory system 210 may be physically removed from a power source (e.g., intentionally, unintentionally) and physically reconnected to the power source. In some examples, the memory system 210 may detect a power cycle. The value stored to the register 230-c may be modified (e.g., modified to satisfy a threshold value, reset, set to zero), in response to detecting the power cycle. The programming mode may be disabled based at on the value stored at the register 230-c being modified. In some examples, the programming mode may be disabled after a power cycle.

After (e.g., in response to) completing a write command (e.g., writing data to a block 225), the memory system controller 215 may modify (e.g., decrement, adjust) the value in the register 230-c. The value in the register 230-c may indicate a remaining amount of data 245 to be written to the memory device 220 during the programming mode. For example, the memory system 210 may receive a first write command and modify (e.g., decrement) the value of the register 230-c in accordance with a quantity of data 245 written to as part performing the first write command. The memory system 210 may modify (e.g., decrement) the value of the register 230-c based on the first write command (e.g., after receiving the first write command, after executing the first write command). Once the value stored to the register 230-c satisfies a threshold value (e.g., the value stored to register 230-c reaches zero), then write operation may be complete (e.g., all the planned data is installed or pre-programmed).

In some cases, the host system 205 may program more data than indicated in the indication 240-c. In some cases, the host system 205 may program less data than declared in the indication 240-c. The host system 205 may set the value stored to the register 230-c to a threshold value (e.g., zero) to notify the memory system 210 that the write operation is complete. In response to the value stored to the register 230-c reaching the threshold value (e.g., zero), the memory system 210 may exit or disable the programming mode (e.g., ISP or PSA mode). In other words, the memory system 210 may assume the programming operation (e.g., procedure) is over and may exit or disable the programming mode without additional commands from the host system 205.

Disabling or delaying operations (e.g., maintenance operations) during the programming mode decreases the time spent to program memory systems 210 in the manufacturing setting. This results in decreases to costs, money, and resources, for example, by increasing a quantity of memory systems 210 that may be programmed (e.g., ready) per day, among other advantages.

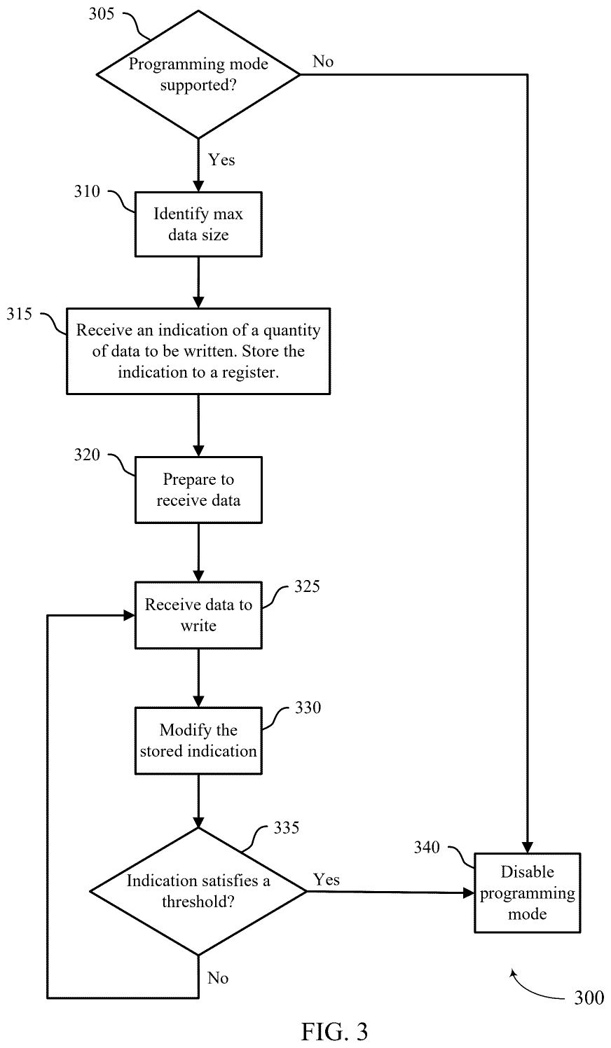

FIG. 3 shows an example of a process 300 that supports fast programming for memory systems in accordance with examples as disclosed herein. The process 300 may implement, or be implemented by, aspects of the system 100 and the system 200 as described herein. For example, the process 300 may be implemented by a memory system, which may be examples of the memory systems as described herein, including with reference to FIGS. 1 and 2. In the following description of the process 300, the methods, techniques, processes, and operations may be performed in different orders or at different times. Further, some operations may be left out of the process 300, or other operations may be added to the process 300.

Aspects of the process 300 may be implemented by one or more controllers, among other components. Additionally, or alternatively, aspects of the process 300 may be implemented as instructions stored in one or more memories (e.g., firmware stored in a one or more memories coupled with the memory system). For example, the instructions, when executed by one or more controllers (e.g., a memory system controller 115), may cause the one or more controllers (or a device or a system) to perform the operations of the process 300.

At 305, whether a system supports a programming mode may be determined. For example, a memory system may communicate with a host system that a programming mode (e.g., feature) is supported by the memory system. For example, the memory system may transmit an indication (e.g., a descriptor, a flag) declaring that the programming node is supported. The memory system may receive a command from the host system, where the command may be a first (e.g., initial) command in a programming command sequence. In some examples, the command may trigger the memory system to operate in the programming mode in response to the memory system indicating to the host system that the programming mode is supported. In response to receiving the command, the memory system may enter the programming mode.

In some examples, the memory system may indicate that the programming mode is not supported by the host system. In this case, the memory system of process 300 may refrain from performing the programming mode. In other words, the memory system of process 300 may skip the programming mode, exiting or disabling the programming mode at 340 without entering or enabling the programming mode or performing operations associated with the programming mode. The memory system of process 300 may, instead, enter a different programming mode and perform associated programming operations.

At 310, a maximum size of supported data may be identified. For example, the host system may read a register to determine a maximum size of supported data. In some examples, the memory system may transmit (e.g., declare, indicate), to the host system, an indication of a quantity (e.g., a maximum size) of data that the memory system may support during the programming mode (e.g., while programming). This indication may be stored to a register of the memory system. The memory system may determine (e.g., read) the indication of the quantity of data based on the stored indication.

The maximum quantity of data that may be supported by the memory system may change over time (e.g., over the lifetime of the memory system, as the memory system is subsequently programmed, as the memory system performs maintenance operations). Accordingly, the maximum quantity of data supported by the memory device may be communicated by the memory system to the host system even if the memory system previously communicated the maximum quantity of data supported (e.g., during a previous programming operation). The host system may initiate programming in response to setting the maximum supported quantity of data (e.g., attribute). For example, the host system can set (e.g., store in a register) an indication (e.g., an attribute descriptor) to initiate the programming mode.

At 315, an indication of a quantity of data to be written may be received and stored to a register. For example, the memory system may receive an indication of a quantity of data to be written to the memory system (e.g., to all logical units). The memory system may store (e.g., write) this indication to a register.

At 320, preparations may be made to receive data. For example, the memory system may prepare to receive the quantity of data indicated at 315. For example, the memory system may set aside blocks (e.g., a NAND footprint) for the programming operation. The memory device may perform maintenance operations such as garbage collection to ensure that enough blocks (e.g., a large enough NAND footprint) are set aside (e.g., reserved). In some examples (e.g., during in-system programming), the memory system may refrain from performing garbage collection and other maintenance operations in response to the blocks being blank (e.g., there is no pre-written data on the blocks to collect). The blocks of the memory system may be empty or almost empty. In other examples, the memory system may perform garbage collection and other maintenance operations in response to the blocks containing some pre-written data.

At 325, data may be received. For example, the memory system may receive one or more write commands and corresponding data to write. The data may be expressed in 4 KB units, other unit sizes, or may vary in size. The data may be received in one or more packets. In some examples, receiving the one or more write commands may be based on receiving the indication of quantity of data to be written at 315. In other examples, receiving the one or more write commands may be based on storing the indication of quantity of data to be written at 315.

At 330, the stored indication may be modified. For example, the memory system may modify (e.g., update, decrement, overwrite) the indication stored (e.g., written) to the register at 315 (or previously modified at 330) in response to receiving the one or more write commands at 325. The modification may include erasing the stored indication and writing (and storing) a new indication based on the erased indication. In some examples, the stored indication may track a remaining quantity of data for the host system to program (e.g., load, install) into the memory system. In some examples, the stored indication may track a remaining quantity of blocks that the memory system has set aside for the programming operation. In some examples, the memory system may transmit the value stored at the register to the host system. The host system may check the register and may set (e.g., overwrite, modify) the value, ensuring that value is lower than or equal to the maximum quantity of data supported by the memory system.

In some examples, the host system may modify the indication that was stored at 315 (or previously modified at 330). In some cases, the host system may indicate (e.g., at 315) a larger quantity of data than is used in the programming operation. The memory system may prepare or set aside more blocks than is used for the programming operation. The host system may modify the indication such that it satisfies a threshold value (e.g., overwrite the indication to be zero). This overwrite may correct an error made by the host system so that the memory device refrains from waiting for data that does not exist and, instead, exits or disables the programming mode once the programming operation is complete.

At 335, whether the indication satisfies a threshold value may be determined. For example, the memory system may determine whether the indication modified at 330 satisfies a threshold value (e.g., whether the indication decremented at 330 is zero). Each write (e.g., at 325) may use up some of the prepared blocks (e.g., use up some of the set aside NAND footprint). The memory system may determine whether there are still prepared blocks to write to during the programming operation. If the indication does not satisfy the threshold value (e.g., is not zero) then the memory system may receive more data from the host system as part of the programming operation. If the indication satisfies a threshold value (e.g., is zero) then the programming operation may be complete.

At 340, the programming mode may be disabled. For example, the memory system of process 300 may exit or disable the programming mode. The host system may set a value (e.g., an indication) to indicate that the host system has completed transmission of data associated with the programming operation to the memory system. After disabling the programming mode, the memory system may operate in a second mode (e.g., a second programming mode). For example, the memory system may return to a previous programming mode or mode of operation or may otherwise function in accordance with a conventional operation. The memory system may perform operations such as read operations, write operations, etc. according to the second mode. The second mode may enable or prioritize operations that were disabled or delayed in the programming mode (garbage collection, etc.).

The process 300 may occur in a controlled setting such as a factory. The environment (temperature, power source, etc.) may be well-defined and controlled, and critical situations may be very unlikely. Accordingly, some programming algorithms may be relaxed. For example, some error management routines, such as those related to temperature and power loss, may be disabled or lessened. Disabling these routines may reduce programming latency.

Disabling or delaying operations (e.g., maintenance operations) during the programming mode decreases the time spent to program memory systems in the manufacturing setting. This results in decreases to costs, money, and resources, for example, in terms of a quantity of technicians managing the programming and a quantity of programmers, and increases a quantity of memory system that may be programmed (e.g., ready) per day, among other advantages.

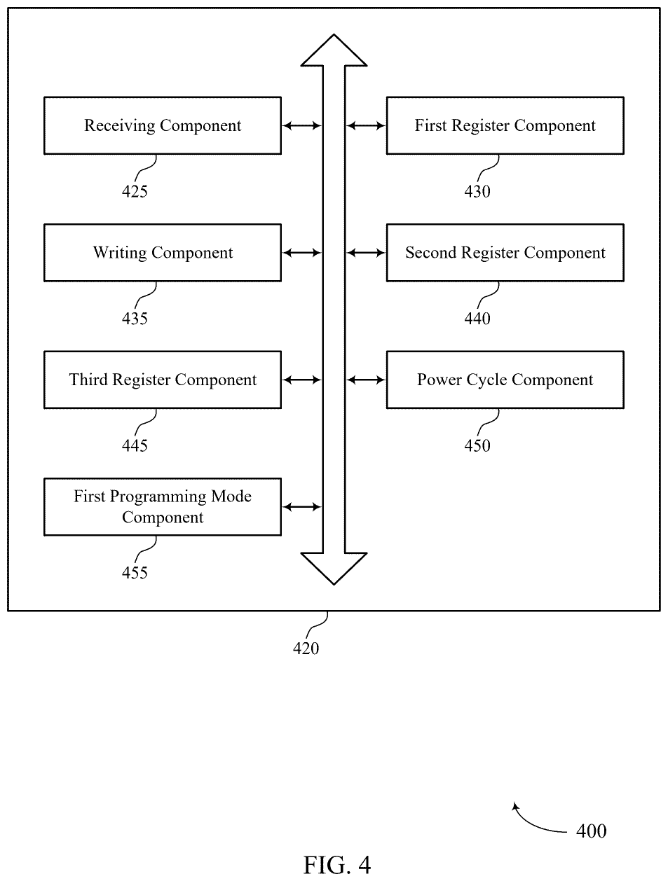

FIG. 4 shows a block diagram 400 of a memory system 420 that supports fast programming for memory systems in accordance with examples as disclosed herein. The memory system 420 may be an example of aspects of a memory system as described with reference to FIGS. 1 through 3. The memory system 420, or various components thereof, may be an example of means for performing various aspects of fast programming for memory systems as described herein. For example, the memory system 420 may include a receiving component 425, a first register component 430, a writing component 435, a second register component 440, a third register component 445, a power cycle component 450, a first programming mode component 455, or any combination thereof. Each of these components, or components of subcomponents thereof (e.g., one or more processors, one or more memories), may communicate, directly or indirectly, with one another (e.g., via one or more buses).

The receiving component 425 may be configured as or otherwise support a means for receiving an indication of a quantity of data to be written to the memory system as part of a first programming mode. The first register component 430 may be configured as or otherwise support a means for storing the indication to a first register of the memory system in response to receiving the indication. In some examples, the receiving component 425 may be configured as or otherwise support a means for receiving, in response to storing the indication to the first register, a portion of the data to be written to the memory system. The writing component 435 may be configured as or otherwise support a means for writing the portion of the data to the memory system using the first programming mode in response to receiving the portion of the data. In some examples, the first register component 430 may be configured as or otherwise support a means for modifying, in response to writing the portion of the data to the memory system, a value stored to the first register.

In some examples, to support modifying the value stored to the first register, the first register component 430 may be configured as or otherwise support a means for decrementing the value stored to the first register in response to writing the portion of the data to the memory system.

In some examples, the first programming mode component 455 may be configured as or otherwise support a means for disabling the first programming mode in response to the value satisfying a threshold value after decrementing the value.

In some examples, the writing component 435 may be configured as or otherwise support a means for writing second data to the memory system using a second programming mode in response to disabling the first programming mode.

In some examples, the second register component 440 may be configured as or otherwise support a means for determining a maximum quantity of data capable of being written using the first programming mode indicated by a first value stored to a second register, where the quantity of data is less than or equal to the maximum quantity of data.

In some examples, the second register component 440 may be configured as or otherwise support a means for modifying the first value to indicate an updated maximum quantity of data capable of being written using the first programming mode.

In some examples, the third register component 445 may be configured as or otherwise support a means for determining whether the memory system is configured to operate using the first programming mode in response to a value stored to a third register of the memory system, where receiving the quantity of data is in response to the value stored to the third register.

In some examples, the first programming mode component 455 may be configured as or otherwise support a means for enabling the first programming mode at the memory system in response to determining that the memory system is configured to operate using the first programming mode, where receiving the quantity of data is in response to enabling the first programming mode.

In some examples, the second register component 440 may be configured as or otherwise support a means for transmitting a maximum quantity of data capable of being written using the first programming mode indicated by a first value stored to a second register in response to enabling the first programming mode.

In some examples, the power cycle component 450 may be configured as or otherwise support a means for detecting a power cycle at the memory system. In some examples, the first register component 430 may be configured as or otherwise support a means for modifying the value stored to the first register in response to detecting the power cycle. In some examples, the first programming mode component 455 may be configured as or otherwise support a means for disabling the first programming mode in response to modifying the value.

In some examples, the first register component 430 may be configured as or otherwise support a means for transmitting the value stored to the first register.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

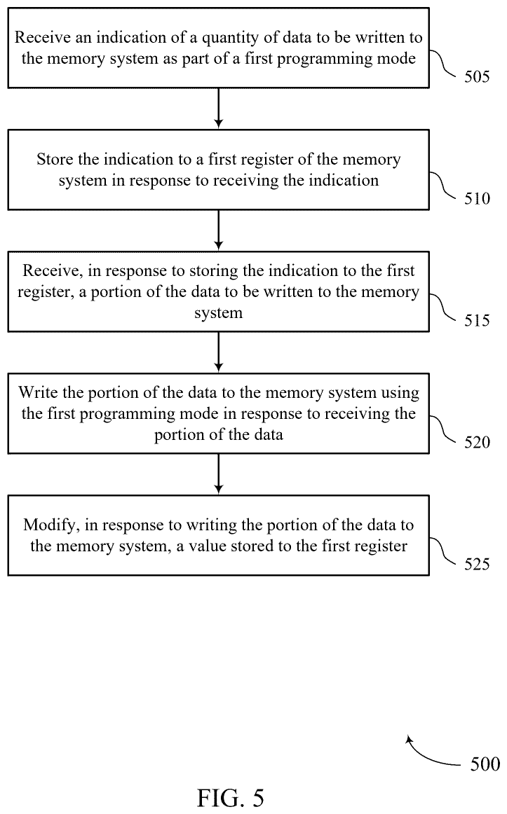

FIG. 5 shows a flowchart illustrating a method 500 that supports fast programming for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving an indication of a quantity of data to be written to the memory system as part of a first programming mode. In some examples, aspects of the operations of 505 may be performed by a receiving component 425 as described with reference to FIG. 4.

At 510, the method may include storing the indication to a first register of the memory system in response to receiving the indication. In some examples, aspects of the operations of 510 may be performed by a first register component 430 as described with reference to FIG. 4.

At 515, the method may include receiving, in response to storing the indication to the first register, a portion of the data to be written to the memory system. In some examples, aspects of the operations of 515 may be performed by a receiving component 425 as described with reference to FIG. 4.

At 520, the method may include writing the portion of the data to the memory system using the first programming mode in response to receiving the portion of the data. In some examples, aspects of the operations of 520 may be performed by a writing component 435 as described with reference to FIG. 4.

At 525, the method may include modifying, in response to writing the portion of the data to the memory system, a value stored to the first register. In some examples, aspects of the operations of 525 may be performed by a first register component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication of a quantity of data to be written to the memory system as part of a first programming mode; storing the indication to a first register of the memory system in response to receiving the indication; receiving, in response to storing the indication to the first register, a portion of the data to be written to the memory system; writing the portion of the data to the memory system using the first programming mode in response to receiving the portion of the data; and modifying, in response to writing the portion of the data to the memory system, a value stored to the first register.

Aspect 2: The method, apparatus, or non-transitory computer-readable medium of aspect 1, where modifying the value stored to the first register includes operations, features, circuitry, logic, means, or instructions, or any combination thereof for decrementing the value stored to the first register in response to writing the portion of the data to the memory system.

Aspect 3: The method, apparatus, or non-transitory computer-readable medium of aspect 2, further including operations, features, circuitry, logic, means, or instructions, or any combination thereof for disabling the first programming mode in accordance with the value satisfying a threshold value after decrementing the value.

Aspect 4: The method, apparatus, or non-transitory computer-readable medium of aspect 3, further including operations, features, circuitry, logic, means, or instructions, or any combination thereof for writing second data to the memory system using a second programming mode based at on disabling the first programming mode.

Aspect 5: The method, apparatus, or non-transitory computer-readable medium of any of aspects 1 through 4, further including operations, features, circuitry, logic, means, or instructions, or any combination thereof for determining a maximum quantity of data capable of being written using the first programming mode indicated by a first value stored to a second register, where the quantity of data is less than or equal to the maximum quantity of data.

Aspect 6: The method, apparatus, or non-transitory computer-readable medium of aspect 5, further including operations, features, circuitry, logic, means, or instructions, or any combination thereof for modifying the first value to indicate an updated maximum quantity of data capable of being written using the first programming mode.

Aspect 7: The method, apparatus, or non-transitory computer-readable medium of any of aspects 1 through 6, further including operations, features, circuitry, logic, means, or instructions, or any combination thereof for determining whether the memory system is configured to operate using the first programming mode in accordance with a value stored to a third register of the memory system, where receiving the quantity of data is in accordance with the value stored to the third register.

Aspect 8: The method, apparatus, or non-transitory computer-readable medium of aspect 7, further including operations, features, circuitry, logic, means, or instructions, or any combination thereof for enabling the first programming mode at the memory system in response to determining that the memory system is configured to operate using the first programming mode, where receiving the quantity of data is in response to enabling the first programming mode.

Aspect 9: The method, apparatus, or non-transitory computer-readable medium of any of aspects 7 through 8, further including operations, features, circuitry, logic, means, or instructions, or any combination thereof for transmitting a maximum quantity of data capable of being written using the first programming mode indicated by a first value stored to a second register in response to enabling the first programming mode.

Aspect 10: The method, apparatus, or non-transitory computer-readable medium of any of aspects 1 through 9, further including operations, features, circuitry, logic, means, or instructions, or any combination thereof for detecting a power cycle at the memory system; modifying the value stored to the first register in response to detecting the power cycle; and disabling the first programming mode in response to modifying the value.

Aspect 11: The method, apparatus, or non-transitory computer-readable medium of any of aspects 1 through 10, further including operations, features, circuitry, logic, means, or instructions, or any combination thereof for transmitting the value stored to the first register.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication of a quantity of data to be written to the memory system as part of a first programming mode;
store the indication to a first register of the memory system in response to receiving the indication;
receive, in response to storing the indication to the first register, a portion of the data to be written to the memory system;
write the portion of the data to the memory system using the first programming mode in response to receiving the portion of the data; and
modify, in response to writing the portion of the data to the memory system, a value stored to the first register.

2. The memory system of claim 1, wherein modifying the value stored to the first register comprises the processing circuitry configured to cause the memory system to:
decrement the value stored to the first register in response to writing the portion of the data to the memory system.

3. The memory system of claim 2, wherein the processing circuitry is further configured to cause the memory system to:
disable the first programming mode in accordance with the value satisfying a threshold value after decrementing the value.

4. The memory system of claim 3, wherein the processing circuitry is further configured to cause the memory system to:
write second data to the memory system using a second programming mode in response to disabling the first programming mode.

5. The memory system of claim 1, wherein the processing circuitry is further configured to cause the memory system to:
determine a maximum quantity of data capable of being written using the first programming mode indicated by a first value stored to a second register, wherein the quantity of data is less than or equal to the maximum quantity of data.

6. The memory system of claim 5, wherein the processing circuitry is further configured to cause the memory system to:
modify the first value to indicate an updated maximum quantity of data capable of being written using the first programming mode.

7. The memory system of claim 1, wherein the processing circuitry is further configured to cause the memory system to:
determine whether the memory system is configured to operate using the first programming mode in accordance with a value stored to a third register of the memory system, wherein receiving the quantity of data is in accordance with the value stored to the third register.

8. The memory system of claim 7, wherein the processing circuitry is further configured to cause the memory system to:
enable the first programming mode at the memory system in response to determining that the memory system is configured to operate using the first programming mode, wherein receiving the quantity of data is in response to enabling the first programming mode.

9. The memory system of claim 7, wherein the processing circuitry is further configured to cause the memory system to:
transmit a maximum quantity of data capable of being written using the first programming mode indicated by a first value stored to a second register in response to enabling the first programming mode.

10. The memory system of claim 1, wherein the processing circuitry is further configured to cause the memory system to:
detect a power cycle at the memory system;
modify the value stored to the first register in response to detecting the power cycle; and
disable the first programming mode in response to modifying the value.

11. The memory system of claim 1, wherein the processing circuitry is further configured to cause the memory system to:
transmit the value stored to the first register.

12. A non-transitory computer-readable medium storing code comprising instructions which, when executed by one or more processors of a memory system, cause the memory system to:
receive an indication of a quantity of data to be written to the memory system as part of a first programming mode;
store the indication to a first register of the memory system in response to receiving the indication;
receive, in response to storing the indication to the first register, a portion of the data to be written to the memory system;
write the portion of the data to the memory system using the first programming mode in response to receiving the portion of the data; and
modify, in response to writing the portion of the data to the memory system, a value stored to the first register.

13. The non-transitory computer-readable medium of claim 12, wherein the instructions to modify the value stored to the first register, when executed by the one or more processors of the memory system, cause the memory system to decrement the value stored to the first register in response to writing the portion of the data to the memory system.

14. The non-transitory computer-readable medium of claim 13, wherein the instructions, when executed by the one or more processors of the memory system, further cause the memory system to disable the first programming mode in accordance with the value satisfying a threshold value after decrementing the value.

15. The non-transitory computer-readable medium of claim 14, wherein the instructions, when executed by the one or more processors of the memory system, further cause the memory system to write second data to the memory system using a second programming mode in response to disabling the first programming mode.

16. The non-transitory computer-readable medium of claim 12, wherein the instructions, when executed by the one or more processors of the memory system, further cause the memory system to determine a maximum quantity of data capable of being written using the first programming mode indicated by a first value stored to a second register, wherein the quantity of data is less than or equal to the maximum quantity of data.

17. The non-transitory computer-readable medium of claim 16, wherein the instructions, when executed by the one or more processors of the memory system, further cause the memory system to modify the first value to indicate an updated maximum quantity of data capable of being written using the first programming mode.

18. The non-transitory computer-readable medium of claim 12, wherein the instructions, when executed by the one or more processors of the memory system, further cause the memory system to determine whether the memory system is configured to operate using the first programming mode in accordance with a value stored to a third register of the memory system, wherein receiving the quantity of data is in accordance with the value stored to the third register.

19. The non-transitory computer-readable medium of claim 18, wherein the instructions, when executed by the one or more processors of the memory system, further cause the memory system to enable the first programming mode at the memory system in response to determining that the memory system is configured to operate using the first programming mode, wherein receiving the quantity of data is in response to enabling the first programming mode.

20. The non-transitory computer-readable medium of claim 18, wherein the instructions, when executed by the one or more processors of the memory system, further cause the memory system to transmit a maximum quantity of data capable of being written using the first programming mode indicated by a first value stored to a second register in response to enabling the first programming mode.

21. The non-transitory computer-readable medium of claim 12, wherein the instructions, when executed by the one or more processors of the memory system, further cause the memory system to:
detect a power cycle at the memory system;
modify the value stored to the first register in response to detecting the power cycle; and
disable the first programming mode in response to modifying the value.

22. The non-transitory computer-readable medium of claim 12, wherein the instructions, when executed by the one or more processors of the memory system, further cause the memory system to transmit the value stored to the first register.

23. A method by a memory system, comprising:
receiving an indication of a quantity of data to be written to the memory system as part of a first programming mode;
storing the indication to a first register of the memory system in response to receiving the indication;
receiving, in response to storing the indication to the first register, a portion of the data to be written to the memory system;
writing the portion of the data to the memory system using the first programming mode in response to receiving the portion of the data; and
modifying, in response to writing the portion of the data to the memory system, a value stored to the first register.

24. The method of claim 23, wherein modifying the value stored to the first register comprises:
decrementing the value stored to the first register in response to writing the portion of the data to the memory system.

25. The method of claim 24, further comprising:
disabling the first programming mode in accordance with the value satisfying a threshold value after decrementing the value.
